(19) United States
(12) Patent Application Publication
(10) Pub. No.: US 2010/0285781 A1
(43) Pub. Date: Nov. 11, 2010

(54) DEPLOYING LEARNING MANAGEMENT SYSTEMS TO MOBILE COMMUNICATIONS DEVICES

(75) Inventors: Juan Dai, Beijing (CN); Yong Riu, Sammamish, WA (US); Dengshan Yuan, Beijing (CN); Shu Chen, Beijing (CN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/463,426

(22) Filed: May 11, 2009

(51) Int. Cl. H04M 3/42; G06F 15/16; G06F 21/20

(52) U.S. Cl. 455/414.1; 709/203; 726/3; 709/204

(57) ABSTRACT

Tools and techniques for deploying learning management systems to mobile communications devices are provided. These tools receive requests from client devices operating within a learning management system, with the request relating to executing commands within the learning management system. The tools execute the commands in response to the requests, and evaluate whether the client devices are mobile client devices. A response to the command is formatted, based on whether the client devices are mobile client devices.

### BACKGROUND

Mobile communications devices are gaining increased acceptance with users around the world. In some cases, these mobile communications devices may incorporate web browsers that provide some degree of access to global communications networks, such as the Internet.

### SUMMARY

Tools and techniques for deploying learning management systems to mobile communications devices are provided. These tools receive requests from client devices operating within a learning management system, with the request relating to executing commands within the learning management system. The tools execute the commands in response to the requests, and evaluate whether the client devices are mobile client devices. A response to the command is formatted, based on whether the client devices are mobile client devices.

It should be appreciated that the above-described subject matter may be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a combined block and flow diagram illustrating systems or operating environments, suitable for deploying learning management systems (LMSs) to mobile communications devices.

FIG. 2 is a block diagram illustrating architectures suitable for implementing mobile client devices and the servers within the learning management systems.

FIG. 3 is a combined block and flow diagram illustrating components and related data flows regarding a server-side LMS and a mobile client-side LMS.

FIG. 4 is a combined block and flow diagram illustrating components and data flows regarding content that may be uploaded and/or downloaded between the mobile client-side LMS and the server-side LMS.

FIG. 5 is a flow diagram illustrating processes for authenticating client devices to participate in the LMSs.

FIG. 6 is a flow diagram illustrating techniques for processing commands in the LMSs.

FIG. 7 is a flow diagram illustrating continuations of the techniques shown in FIG. 6.

### DETAILED DESCRIPTION

The following detailed description provides tools and techniques for learning management systems to mobile communications devices. While the subject matter described herein presents a general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

The following detailed description refers to the accompanying drawings that form a part hereof, and that show, by way of illustration, specific example implementations. Referring now to the drawings, in which like numerals represent like elements through the several figures, this description provides various tools and techniques related to learning management systems to mobile communications devices.

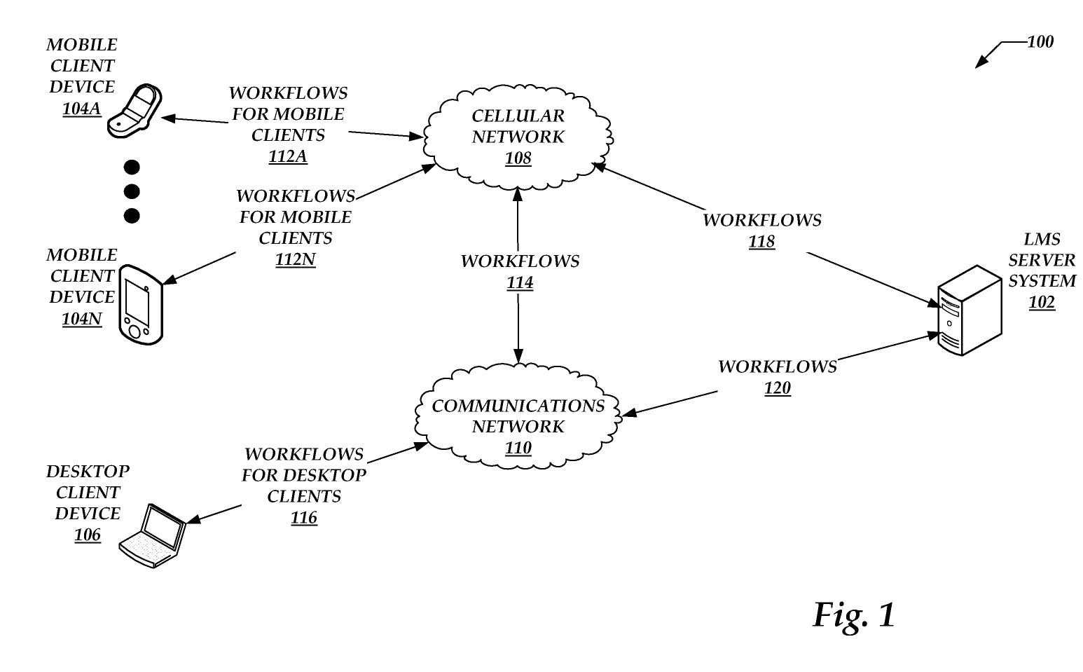

FIG. 1 illustrates systems or operating environments, denoted generally at 100, related to deploying learning management systems to mobile communications devices. Turning to FIG. 1 in more detail, these systems 100 may include any number of server systems or servers 102, with FIG. 1 illustrating one server system 102 only for clarity of illustration.

The servers 102 may coordinate operations of the learning management systems (LMSs), as deployed to any number of mobile client devices 104a and 104n (collectively, mobile client devices 104), as well as desktop client devices 106. The mobile client devices 104 are described in further detail below. However, in overview, the servers 102 may communicate with the mobile client devices 104 over one or more cellular communications networks 108. In some implementations scenarios, the servers 102 may communicate directly to the cellular networks 108. However, in other scenarios, the servers 102 may communicate with the cellular networks 108 through one or more intermediate communications networks 110. The latter communications networks 110 may represent global, wide-area, regional, or local-area networks.

In general, work flows related to the learning management systems may pass between the servers 102, the mobile client devices 104, and/or the desktop client devices 106. Unless otherwise noted to the contrary, these workflows as described herein may represent bidirectional or unidirectional workflows. FIG. 1 represents at 112a workflows passing between the mobile client device 104a and the cellular network 108, and represents at 112n workflows passing between the mobile client device 104n and the cellular network 108. Workflows relating to the mobile clients 104 that pass between the cellular network 108 and the communications network 110 are represented at 114. Workflows passing between the desktop client device 106 and the communications network 110 are denoted at 116.

Turning to the servers 102, FIG. 1 denotes at 118 workflows that pass between the servers 102 and the cellular networks 108. In addition, FIG. 1 denotes at 120 workflows passing between the servers 102 and the communications networks 110.

Subsequent drawings and related description provide further details relating to the various workflows 112-120 shown in FIG. 1. In general, the various workflows 112-120 represent commands and/or data passing between the servers 102, the mobile client devices 104, and/or the desktop client devices 106.

The operating environments 100 may support any number of mobile client devices 104 and/or desktop client devices 106, with the scenario shown in FIG. 1 understood as illustrative rather than limiting. In different implementation scenarios, the mobile client devices 104 may include, but are not limited to: mobile communications devices, cellular telephones, smartphones, wireless-enabled personal digital assistants (PDAs), or the like. The desktop client devices 106 may represent personal computers (PCs) whether characterized as desktops, notebooks, laptops, netbooks, or the like.

Comparing the mobile client devices 104 to the desktop client devices 106, the mobile client devices 104 are generally characterized by smaller display screens and more limited input mechanisms, relative to the desktop client devices 106. In addition, the desktop client devices 106 may receive Internet service through the communications networks 110. In some cases, the communications networks 110 may provide broadband or other high-speed Internet service to the desktop client devices 106. On the other hand, the cellular networks 108 through which the mobile client devices 104 communicate may have relatively low bandwidth, as compared to the communications networks 110. Although the cellular networks 108 may serve wider geographic areas, the cellular networks 108 may or may not provide bandwidth and data transmission capacity that is comparable to the communication networks 110.

As detailed further throughout this description, the servers 102 may deploy the learning management systems to the mobile client devices 104 and/or the desktop client devices 106, thereby integrating the mobile client devices 104 with any desktop client devices 106 operating in the learning management systems. In addition, the servers 102 may tailor their processing, depending on whether the results of this processing is destined for rendering on the mobile client devices 104 or the desktop client devices 106.

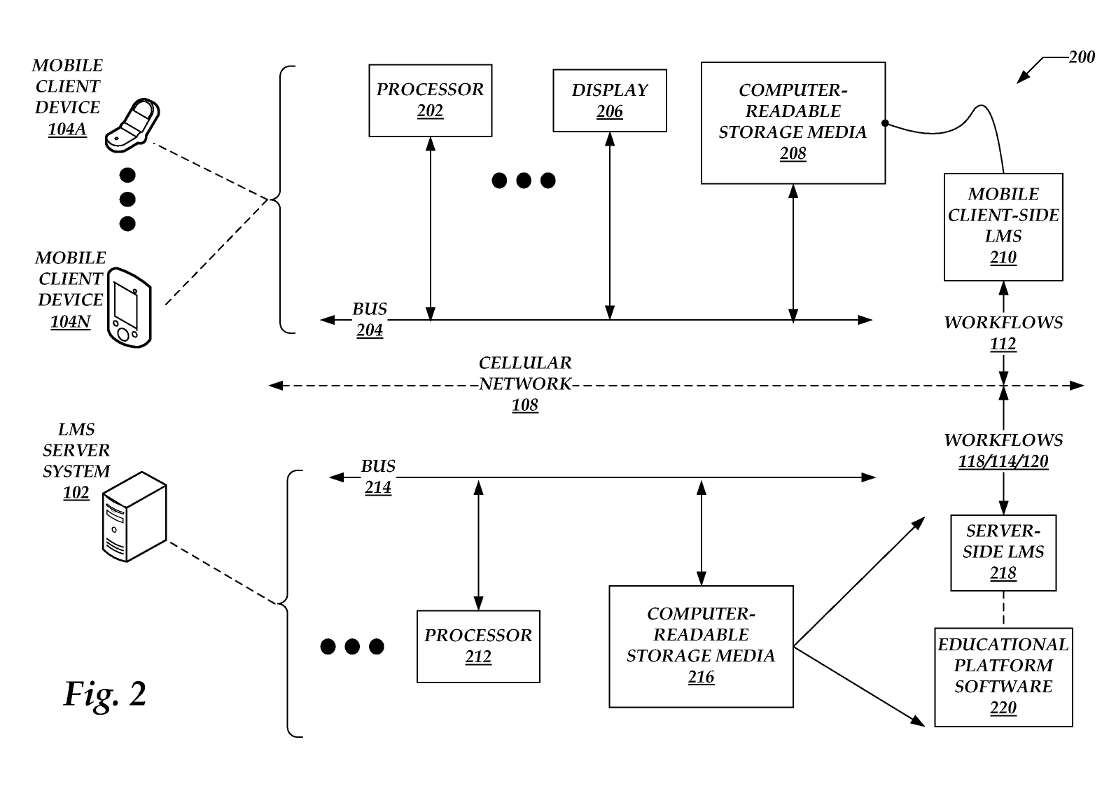

FIG. 2 illustrates architectures, denoted generally at 200, suitable for implementing the mobile client devices and the servers. Without limiting possible implementations, FIG. 2 carries forward examples of the mobile client devices at 104 and examples of the servers at 102.

Turning to the mobile client devices 104 in more detail, these devices may include one or more instances of processing hardware, with FIG. 2 providing a processor 202 as an example of such processing hardware. The processors 202 may have a particular type or architecture, chosen as appropriate for particular implementations. In addition, the processors 202 may couple to one or more bus systems 204, having type and/or architecture that is chosen for compatibility with the processors 202.

The mobile client devices 104 may also include one or more instances of display hardware or screens 206, coupled to communicate with the bus systems 204. The display screens 206 may take different forms, depending on the capabilities of different particular mobile client devices 104. The display screens 206 may be constructed with any suitable technology, recognized as appropriate in different implementation scenarios. In general, the display screens 206 may present data or information in visible form to any number of human users associated with the mobile client devices 104. In addition, the display screens 206 may also receive input from those users, provided using any suitable input means. For example, the display screens may be implemented with touch-sensitive technology, and be responsive to user input registered by touch. However, implementations of this description may operate with other input mechanisms (e.g., keyboards, keypads, or the like), without departing from the scope and spirit of this description.

The mobile client devices 104 may include one or more instances of a physical computer-readable storage medium or media 208, which couple to the bus systems 204. The bus systems 204 may enable the processors 202 to read code and/or data to/from the computer-readable storage media 208. The media 208 may represent apparatus in the form of storage elements that are implemented using any suitable technology, including but not limited to semiconductors, magnetic materials, optics, or the like. The media 208 may represent memory components, whether characterized as RAM, ROM, flash, solid-state hard drive, or other types of technology.

The storage media 208 may include one or more modules of software instructions that, when loaded into the processor 202 and executed, cause the mobile client devices 104 to operate in connection with deploying learning management systems to mobile communications devices. As detailed throughout this description, these modules of instructions may also provide various tools or techniques by which the mobile client devices 104 may participate within the overall systems or operating environments 100 using the components, message and command flows, and data structures discussed in more detail throughout this description. For example, the storage media 208 may include one or more client-side software modules 210 that deploy learning management systems to the mobile communications devices.

In general, the client-side software modules for deploying the learning management systems to the mobile communications devices may, when loaded into the processors 202 and executed, transform the processors 202 and the overall mobile client devices 104 from general-purpose computing systems into special-purpose computing systems customized to operate client-side portions of the learning management systems. The processors 202 may be constructed from any number of transistors or other discrete circuit elements, which may individually or collectively assume any number of states. More specifically, the processors 202 may operate as a finite-state machine, in response to executable instructions contained within software modules (e.g., 210) stored on the media 208. These computer-executable instructions may transform the processors 202 by specifying how the processors 202 transition between states, thereby physically transforming the transistors or other discrete hardware elements constituting the processors 202.

Encoding the software modules that deploy the learning management systems to the mobile client devices 104 may also transform the physical structure of the storage media 208. The specific transformation of physical structure may depend on various factors, in different implementations of this description. Examples of such factors may include, but are not limited to: the technology used to implement the storage media 208, whether the storage media 208 are characterized as primary or secondary storage, and the like. For example, if the storage media 208 are implemented as semiconductor-based memory, the software deploying the learning management systems to the mobile client devices 104 may transform the physical state of the semiconductor memory, when the software is encoded therein. For example, the software may transform the states of transistors, capacitors, or other discrete circuit elements constituting the semiconductor memory.

As another example, the storage media 208 may be implemented using magnetic or optical technology. In such implementations, the software deploying the learning management systems to the mobile client devices 104 may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope and spirit of the present description, with the foregoing examples provided only to facilitate this discussion.

In general, the mobile client-side software 210 may operate to send and receive the workflows 112 through the cellular network 108. These workflows 112 may pass through the cellular network 108, and may reach the server systems 102 as workflows 118 or 114/120.

Turning to the servers 102 in more detail, these servers may include one or more instances of processing hardware, with FIG. 2 providing a processor 212 as an example of such processing hardware. The processors 212 may have a particular type or architecture, chosen as appropriate for particular implementations. The processors 212 may or may not be of the same type or architecture as the processors 202 described above. In addition, the processors 202 may couple to one or more bus systems 214, having type and/or architecture that is chosen for compatibility with the processors 212.

The servers 102 may include one or more instances of a physical computer-readable storage medium or media 216, which couple to the bus systems 214. The bus systems 214 may enable the processors 212 to read code and/or data to/from the computer-readable storage media 216. The media 216 may represent apparatus in the form of storage elements that are implemented using any suitable technology, including but not limited to semiconductors, magnetic materials, optics, or the like. The media 216 may represent memory components, whether characterized as RAM, ROM, flash, or other types of technology. The media 216 may also represent secondary storage, whether implemented as hard drives, CD-ROMs, DVDs, or the like. Hard drive implementations may be characterized as solid state, or may include rotating media storing magnetically-encoded information.

The storage media 216 may include one or more modules of software instructions that, when loaded into the processor 212 and executed, cause the servers 102 to participate in deploying the learning management systems to the mobile client devices 104. As detailed throughout this description, these modules of instructions may also provide various tools or techniques by which the servers 102 may participate within the overall systems or operating environments 100 using the components, flows, and data structures discussed in more detail. The storage media 216 may include one or more server-side software modules 218 that operate in connection with deploying the learning management systems to the mobile client devices 104.

The server-side software 218 may cooperate with educational platform software 220. In general, the platform software 220 may enable collaboration between any number of the mobile client devices 104 and/or desktop client devices 106. For example, the platform software 220 may enable communication between the server systems 102 and browser components running on the mobile client devices 104 and/or desktop client devices 106. In addition, the platform software 220 may manage any documents maintain within the learning management systems, on behalf of the mobile client devices 104 and/or desktop client devices 106. Examples of the platform software 220 may include the SHAREPOINT® services available from Microsoft Corporation of Redmond, Wash. The platform software 220 may also include the SHAREPOINT® Learning Kit, also available from Microsoft. However, the platform software 220 may also represent other software packages having capabilities equivalent to or similar to those described herein.

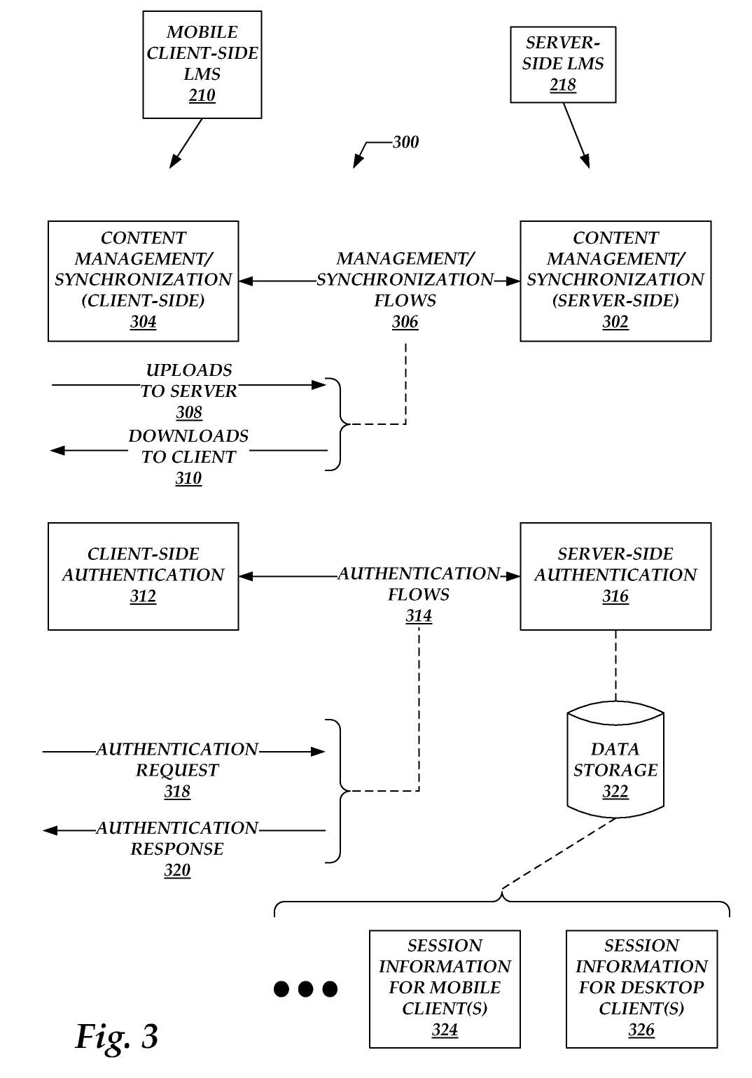

FIG. 3 illustrates components and related data flows, denoted generally at 300, that provide more detail regarding a server-side learning management system (e.g., as implemented by the software modules 218) and a mobile client-side learning management system (e.g., as implemented by the software modules 210). For ease of reference and description, but not to limit possible implantations, FIG. 3 carries forward examples of the server-side and client-side learning management systems from FIG. 2. However, implementations of this description may perform the data flows 300 with other components, without departing from the scope and spirit of the present description.

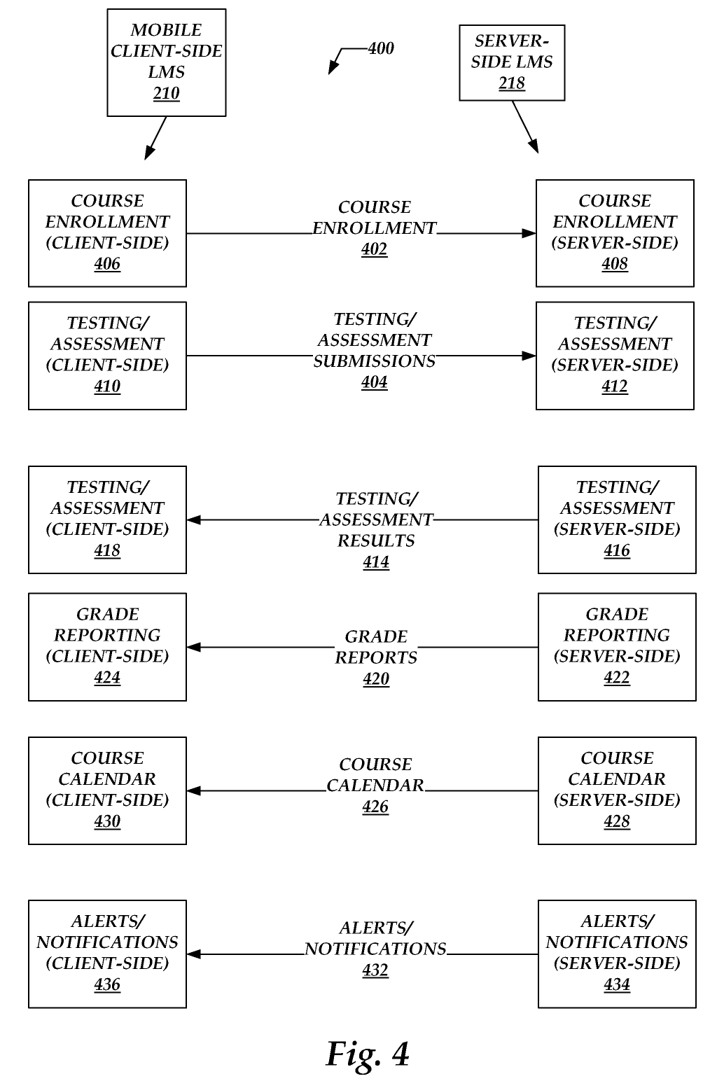

It is also noted that the components and data flows 300 may provide examples of the workflows 112, 118, and 114/120 as shown in FIGS. 1 and 2. In addition, the features and capabilities described below in connection with FIGS. 4-7 fight further examples of the workflows 112, 118, and 114/120.

Turning to the components and data flows 300 in more detail, these server-side learning management system (LMS) 218 and the client-side LMS 210 may cooperate to manage and synchronize content related to the LMS. FIG. 3 represents at 302 examples of server-side software that participates in managing or synchronizing LMS-related content. The server-side software 302 may cooperate with client-side software 304. FIG. 3 also represents at 306 data and/or process flows and/or content related to managing or synchronizing the LMS-related content. This LMS-related content 306 may be stored respectively on the mobile client devices 104, and/or the desktop client devices 106, and then synchronized over to the LMS server system 102, and vice versa. Examples of this content may include, but is not limited to documents or other materials related to courses of instruction offered through the LMS.

Additional examples of this content may include updates to educational materials exchanged between the server-side LMS 218 and the client-side LMS 210. In some cases, these educational materials may be updated over time, in response to changes in status, actions, or occurrences of events related to particular courses of instruction. In such cases, content in the form of these educational materials may be synchronized between the server-side LMS 218 and the client-side LMS 210 in real time with the occurrences of such actions or events.

As shown in FIG. 3, the management/synchronization flows 306 may include uploads from the mobile client-side LMS 210 to the server-side LMS 218, as represented generally at 308. In addition, the management/synchronization flows 306 may include downloads from the server-side LMS 218 to the client-side LMS 210, as represented generally at 310. Examples of content that may be uploaded or downloaded as part of the flows 306 are described in further detail below.

The server-side LMS 218 and the mobile client-side LMS 210 may also cooperate to authenticate users to access the LMS. For example, client-side authentication components are represented at 312, exchanging authentication flows 314 with server-side authentication components 316.

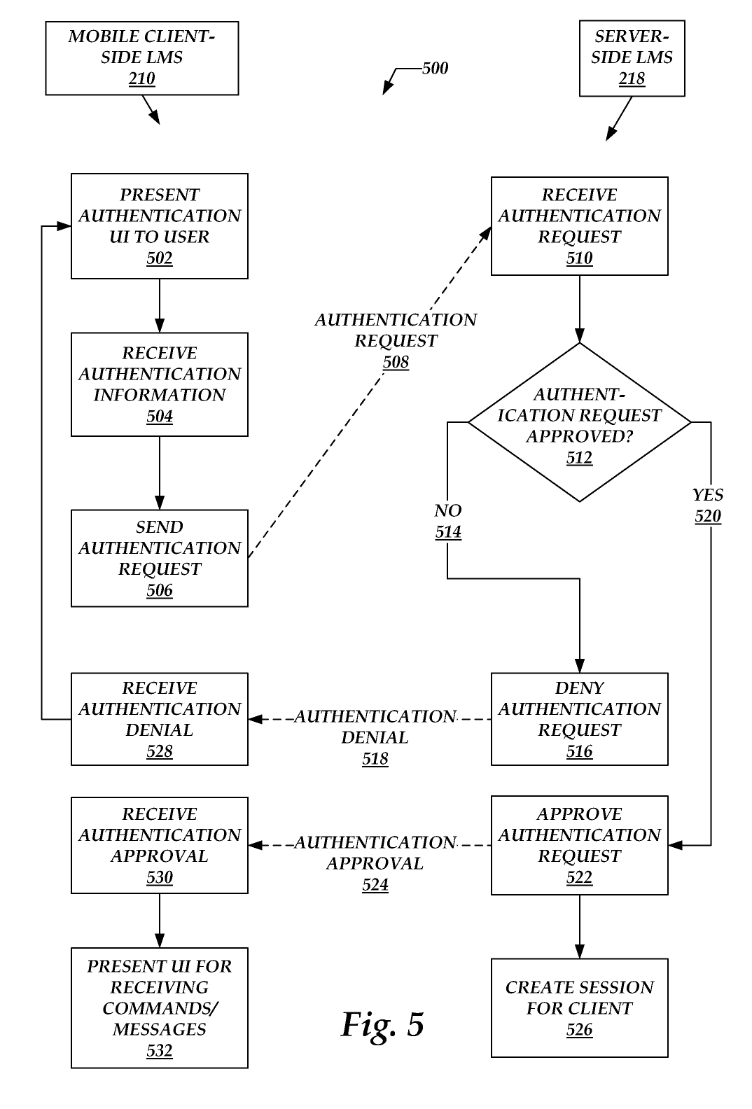

Turning to the authentication flows 314 in more detail, is authentication flows may include authentication requests 318 submitted by the client-side authentication components 312. In response to the authentication request 318, the server-side authentication components 316 may provide authentication responses 320. Illustrative processing related to the authentication requests 318 and the related responses 320 is described in further detail below with FIG. 5.

As shown in FIG. 3, the server-side authentication components 316 may maintain storage 322. The storage 322 may contain session information 324 representing those mobile client devices (e.g., 104a and 104n in FIG. 1) that have authenticated and logged into the LMS system at a given time. In addition, the storage 322 may contain session information 326 representing those desktop clients (e.g. 106 in FIG. 1) that have authenticated and logged into the LMS system. As described in further detail below, components of the server-side LMS 218 may tailor processing more different clients, depending on whether those clients are relatively compact mobile client devices (e.g., 104a and 104n) or are relatively larger desktop devices (e.g., 106). Accordingly, the server-side LMS 218 may refer to the session information 324 and 326 to classify a given client device as a mobile device or as a desktop device when determining whether or how to tailor messages routed to that given client device.

FIG. 4 illustrates components and data flows, denoted generally at 400, that provide additional details regarding content that may be uploaded and/or downloaded between the mobile client-side LMS 210 and the server-side LMS 218. As above with FIG. 3, FIG. 4 carries forward the client-side LMS 210 and the server-side LMS 218 only for example in providing this description.

Turning to the components and data flows 400 in more detail, examples of content that may be uploaded by the mobile client-side LMS 210 to the server-side LMS 218 may include, but is not limited to, course enrollment information 402 and submissions 404 related to particular tasks or assessments taken by a given user. Accordingly, the mobile client-side LMS 210 may include client-side software components 406 that operate to receive information from users regarding particular courses offered through the LMS, and operate to transmit the course enrollment information 402 to the server-side LMS 218. In turn, the server-side LMS 218 may include software components 408 that receive the course enrollment information 402, and that update enrollment records in response to the enrollment information 402.

Regarding the submissions 404 relating to tests or assessments taken by users, the mobile client-side LMS 210 may include software components 410 operative to receive the test or assessment information from users of the LMS. In turn, the software components 410 may transmit the submissions 404 to the server-side LMS 218. More specifically, the server-side LMS 218 may include server-side software components 412 for receiving and storing the testing/assessment submissions 404. In turn, the software components 412 may route or queue the submissions 404 as appropriate for grading or evaluation.

Examples of content that may be downloaded from the server-side LMS 218 to the mobile client-side LMS 210 may include, but are not limited to, results 414 of particular tasks or assessments taken by users of the LMS. Examples of such users may include students enrolled in particular courses offered, at least in part, through the LMS. Accordingly, the server-side LMS 218 may include software components 416 operative to send the testing/assessment results 414 to corresponding client-side software components 418. In turn, the client-side software components 418 may render the testing/assessment results 414 on the mobile device for viewing by the user upon request.

Other examples of downloaded content may include grade reports 420, which may represent grades on particular examinations, projects, courses as a whole, and the like. Accordingly, the server-side LMS 218 may include software components 422 that are operative to transmit the grade reports 420 to the mobile client-side LMS 210. In turn, the mobile client-side LMS 210 may include software components 424 that are operative to receive and store the grade reports 420. In addition, the software components 424 may render the grade reports 420 on the mobile device for viewing by the user upon request.

Either automatically or in response to requests by users, the server-side LMS 218 may send information representing course calendars 426 to the mobile client-side LMS 210. These course calendars 426 may, for example, indicate when particular classes or courses are available for enrollment by users within the LMS. Accordingly, the server-side LMS 218 may include software components 428 operative to send information representing the course calendars 426 to any number of the mobile client-side LMSs 210. In turn, the client-side LMS 210 may include software components 430 for receiving the course calendar information 426, and rendering it upon request on the mobile client devices (e.g., 104).

Either automatically or in response to requests by users, the server-side LMS 218 may send information representing alerts or notifications 432 to the mobile client-side LMSs 210 associated with different mobile client devices 104. These alerts or notifications may relate to upcoming events occurring in courses for which a given user is enrolled. Examples of such events may include upcoming tasks or examinations, project due dates, or the like.

To facilitate the foregoing functions, the server-side LMS 218 may include software components 434 that are operative to send the alerts or notifications 432 to corresponding components 436 provided by the mobile client-side LMS 210. In turn, the components 436 may render the alerts or notifications 432 on the mobile client devices.

FIG. 5 illustrates process flows, denoted generally at 500, or authenticating client devices for participation in the LMSs provided in this description. Without limiting possible implementations of this description, the process flows 500 are described in connection with the mobile client-side LMS 210 and the server-side LMS 218. However, implementations of this description may perform at least part of the process flows 500 with other components, without departing from the scope and spirit of this description.

Turning to the process flows 500 more detail, description of these process flows may begin with authenticating a given user to access the features and capabilities provided by the server-side LMS 218. Accordingly, referring to the mobile client-side LMS 210, block 502 represents presenting a user interface (UI) adapted to obtain authentication information from a given user. Examples of the authentication information may include, but are not limited to, username/password combinations.

Block 504 represents receiving authentication information from the user, in response to the authentication UI presented in block 502. In turn, block 506 represents sending an authentication request 508 to the server-side LMS 218. The authentication request 508 may incorporate the authentication information obtained from the given user. In addition, the authentication request 508 a represent part of the authentication flows 314 described above in FIG. 3.

Referring to the server-side LMS 218, block 510 represents receiving the authentication request 508. In turn, decision block 512 represents evaluating whether to approve the authentication request 508. For example, decision block 512 may include validating a username/password provided with the authentication request 508.

From decision block 512, if authentication information provided with the authentication request 508 is invalid, the process flows 500 may take No branch 514 to block 516, which represents denying the authentication request 508. Block 516 may also include transmitting an authentication denial 518 to the mobile client-side LMS 210.

Returning to decision block 512, if the authentication information provided with the authentication request 508 is valid, the process flows 500 may take Yes branch 520 to block 522, which represents approving the authentication request 508. Block 522 may also include transmitting an authentication approval 524 to the mobile client-side LMS 210.

Once a given client is authenticated to the server-side LMS 218, block 526 represents creating a session for that given client. As shown above in FIG. 3, the sessions may indicate that the given client is a mobile client (e.g., block 324), or may indicate that the given client is a desktop client (e.g., block 326). As described elsewhere herein, the session information may enable the server-side LMS 218 to tailor its processing according to the physical layout and functional capabilities of particular client devices.

As appreciated from the foregoing description, the server-side LMS 218 may provide the authentication denial 518 or the authentication approval 524 in response to the authentication request 508. In addition, it is noted that the authentication flows 314 described above in FIG. 3 may include the authentication denial 518 and/or the authentication approval 524.

Referring to the mobile client-side LMS 210, block 528 represents receiving the authentication denial 518. Block 528 may also include providing a message or notification to the user, to indicate that server-side LMS 218 denied the authentication request 508. Afterwards, the process flows 500 may return to block 502, to present the authentication UI to the user, thereby enabling the user to repeat the authentication process if he or she so wishes. In this manner, the user may correct any authentication information that he or she entered erroneously.

Block 530 represents receiving the authentication approval 524, in response to the authentication request 508. In turn, block 532 represents providing a UI to the user suitable for receiving commands from the user related to participation in the LMS. In addition, the UI presented in block 532 may include areas suitable for rendering any messages received from the server-side LMS 218, related to the user's participation in the LMS.

It is noted that the process flows 500 may be performed, at least in part, to authenticate any number of client systems or devices to interact with the server-side LMS 218. These client systems or devices may be characterized as mobile client devices having relatively limited display and processing capabilities, as compared to desktop client devices.

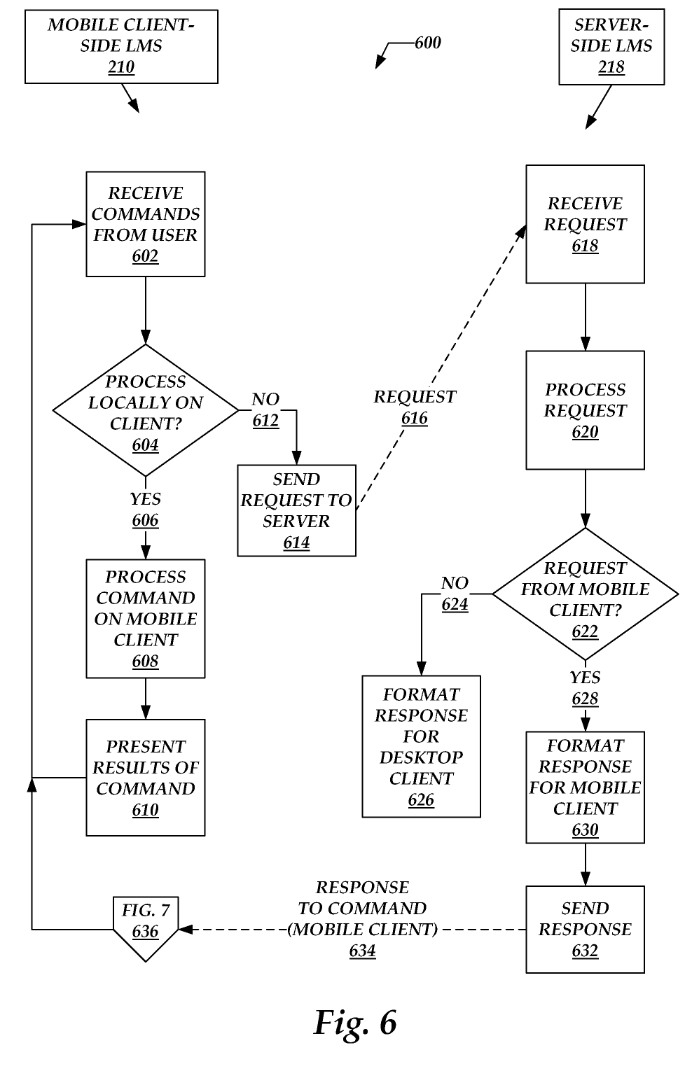

FIG. 6 illustrates process flows, denoted generally at 600, for processing commands in the LMS systems provided herein. Without limiting possible implementations of this description, the process flows 600 are described in connection with the mobile client-side LMS 210 and the server-side LMS 218. However, implementations of this description may perform at least part of the process flows 600 with other components, without departing from the scope and spirit of this description.

Turning to the process flows 600 in more detail, block 602 represents receiving one or more commands from a user participating in the LMS. Examples of commands received by block 602 may include, but are not limited to, commands related to enrolling in courses offered through the LMS (e.g., enrollment information 402 in FIG. 4), commands related to providing testing or assessment information (e.g., submissions 404 in FIG. 4) for submission to the server-side LMS 218.

In implementations in which the client-side LMS 210 is deployed onto a relatively low-powered mobile client device (e.g., 104a and 104n in FIG. 1), it may be beneficial to offload processing from the mobile client device onto the LMS server 102. Accordingly, decision block 604 represents evaluating whether to process or respond to a given command locally at the mobile client-side LMS 210, or to offload processing of that given command to the server-side LMS 218. Decision block 604 may include considering factors such as the processing capabilities of a given mobile client device, the anticipated processing burden associated with a given command, and the like.

From decision block 604, if the given command is to be processed locally, the process flows may take Yes branch 606 to block 608. Block 608 represents processing the command locally on a mobile client. In turn, block 610 represents presenting any results of executing the command on the mobile client. Afterwards, the process flows 600 may return to block 602 to await further commands from the user.

Returning to decision block 604, if the given command is to be offloaded for processing to the server-side LMS 218, the process flows 600 may take No branch 612 to block 614. Block 614 represents sending a request 616 to the LMS server to process the given command.

Referring to the server-side LMS 218, block 618 represents receiving the request 616 from the mobile client-side LMS 210. In turn, block 620 represents processing the request, to generate a response or result associated with the request.

Decision block 622 represents evaluating whether the request 616 originate from a mobile client device (e.g., 104a or 104n in FIG. 1), or from a desktop client device (e.g., 106 in FIG. 1). Depending on whether a mobile client device or a desktop client device originated a given request 616, the server-side LMS may tailor its processing according to the capabilities of the requesting client device.

From decision block 622, if a desktop client device originated the request 616, the process flows 600 may take No branch 624 to block 626. Block 626 represents formatting a response as appropriate for presentation and rendering on a desktop client device.

Returning to decision block 622, if a mobile client device originated the request 616, the process flows 600 may take Yes branch 628 to block 630. Block 630 represents formatting a response to the request 616 for rendering on a mobile client device. As described above, mobile client devices, such as those shown at 104a and 104n in FIG. 1, may include displays having relatively small physical sizes or form factors. For example, block 630 may include applying particular compression techniques to any images included within the response, suitable for rendering within such relatively small displays. In some cases, block 630 may include removing images altogether from a given response.

In addition, assuming that the response to the request 616 is presented in browser software on the client devices, block 630 may include formatting the response as appropriate for rendering within a mobile browser running on the mobile client devices 104, as compared to a browser running on the desktop client device 106.

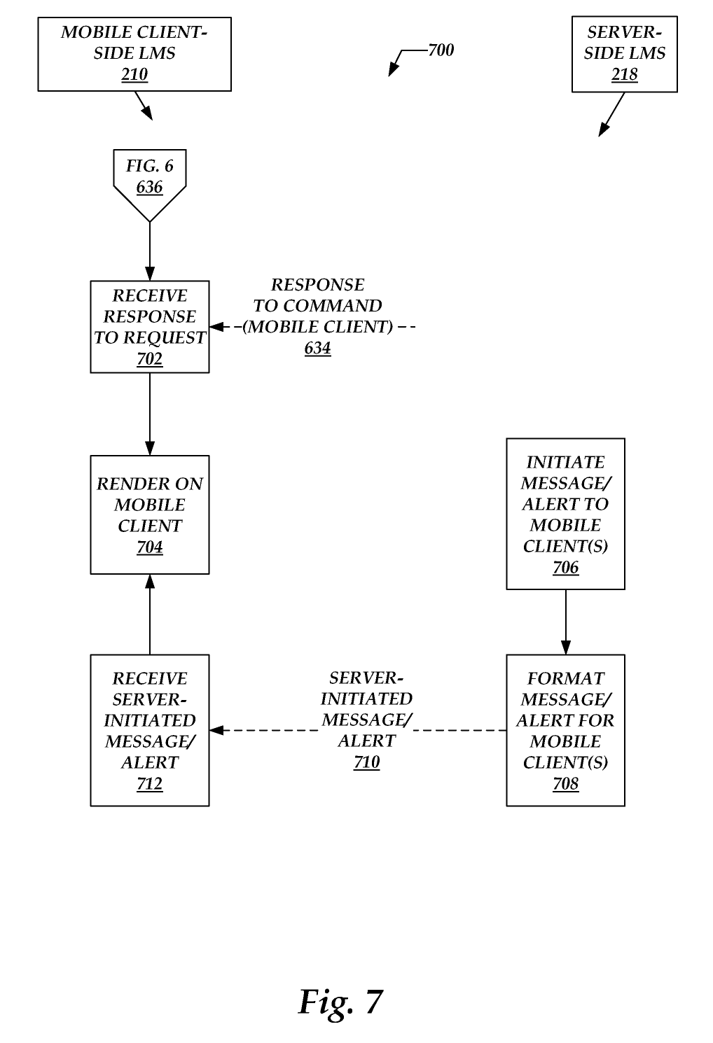

Block 632 represents sending a response 634 from the server-side LMS 218 to the mobile client-side LMS 210. The response 634 may be tailor or formatted as appropriate for rendering on the mobile client devices 104. Without limiting possible implementations, and only for clarity of illustration, the description of the process flows at 600 continues to FIG. 7 via off-page reference 636.

FIG. 7 illustrates process flows, denoted generally at 700, continuing the process flows 600 shown in FIG. 6. Without limiting possible implementations of this description, the process flows 700 are also described in connection with the mobile client-side LMS 210 and the server-side LMS 218. However, implementations of this description may perform at least part of the process flows 700 with other components, without departing from the scope and spirit of this description.

Beginning at the off page reference 636 to FIG. 6, block 702 represents receiving the response 634, carried forward from FIG. 6. As described previously, the response 634 may be tailor or formatted as appropriate for rendering within the relatively smaller confines of mobile client devices (e.g., 104). In turn, block 704 represents rendering the response 634 on the mobile client devices, for viewing by users accessing the mobile client devices.

As described above with FIG. 4, some actions occurring within the LMS may be initiated by the mobile client-side LMS 210, and other actions may be initiated by the server-side LMS 218. The process flows 600 shown in FIG. 6 illustrates example processing associated with the mobile client-side LMS issuing requests to the server-side LMS 218. However, some actions occurring within the LMS may be initiated by the server-side LMS 218. FIG. 4 provides illustrative examples of server-initiated actions at 414, 420, 426, and 432, and FIG. 7 provides examples of process flows associated with such server-initiated actions.

As examples of server-initiated actions, block 706 represents initiating a message, notification, or alert (e.g., 432 in FIG. 4) to be sent to any number of mobile client devices (e.g., 104). In turn, block 708 represents formatting the messages or alerts, denoted generally at 710, as appropriate for transmission and rendering on the mobile client devices 104. Block 708 may apply considerations similar to those described above in connection with block 630 in FIG. 6.

At the mobile client-side LMS 210, block 712 represents receiving the server-initiated message or alert 710. In turn, the process flows 700 may perform block 704 to renders the server-initiated message or alert 710 on the mobile client device 104.

It is noted that the process flows 600 and 700 as shown in FIGS. 6 and 7 may be repeated indefinitely, to process any number of actions occurring between a mobile client-side LMS 210 and the server-side LMS 218. However, in the interests of clarity, FIGS. 6 and 7 do not explicitly illustrate this repetitive processing.

The foregoing description provides technologies for deploying learning management systems to mobile communications devices. Although this description incorporates language specific to computer structural features, methodological acts, and computer readable media, the scope of the appended claims is not necessarily limited to the specific features, acts, or media described herein. Rather, this description provides illustrative, rather than limiting, implementations. Moreover, these implementations may modify and change various aspects of this description without departing from the true spirit and scope of this description, which is set forth in the following claims.

We claim:

1. Apparatus comprising at least one physical computer-readable storage medium having stored thereon computer-executable instructions that, when loaded into at least one hardware processor and executed, transform the hardware processor to perform the following:
receive a request from at least one client device operating within a learning management system, wherein the request relates to executing a command within the learning management system;
execute the command in response to the request;
evaluate whether the client device is a mobile client device; and
format a response to the command based on whether the client device is a mobile client device.

2. The apparatus of claim 1, wherein the instructions to receive a request include instructions to receive a request to authenticate the client device to participate in the learning management system.

3. The apparatus of claim 1, wherein the instructions to receive a request include instructions to receive a request to upload content from the client device to a server system operating within the learning management system.

4. The apparatus of claim 1, wherein the instructions to receive a request include instructions to receive a request to download content to the client device from a server system operating within the learning management system.

5. The apparatus of claim 1, further comprising instructions to determine that the client system is a mobile client system, and wherein formatting a response includes formatting the response for rendering on the mobile client device.

6. The apparatus of claim 5, further comprising instructions to compress content for downloading to the mobile client device.

7. The apparatus of claim 5, wherein the instructions to format the response include instructions to format the response for rendering on a compact display screen provided by the mobile client device.

8. The apparatus of claim 1, further comprising instructions to synchronize status information related to the learning management system between the client device and a server system, in real time with occurrence of events represented in the status information.

9. The apparatus of claim 1, further comprising instructions to receive a request to authenticate the client device to participate in the learning management system.

10. The apparatus of claim 9, further comprising instructions to approve the authentication request.

11. The apparatus of claim 10, further comprising instructions to determine that the client device is a mobile communications device, and further comprising instructions to establish a session within the learning management system that designates the client device as a mobile communications device.

12. The apparatus of claim 1, further comprising instructions to send to the client device data representing a course calendar.

13. The apparatus of claim 1, further comprising instructions to send to the client device data representing least one alert related to the learning management system.

14. Apparatus comprising at least one physical computer-readable storage medium having stored thereon computer-executable instructions that, when loaded into at least one hardware processor and executed, transform the hardware processor to perform the following:
receive at least one command from a user participating within a learning management system using a mobile client device;
evaluate whether to process the command locally at the mobile client device; and
providing a response to the command.

15. The apparatus of claim 14, further comprising instructions to send a request to process the command to a server operating within the learning management system, and further comprising instructions to receive a response to the request from the server.

16. The apparatus of claim 14, wherein the instructions to receive at least one command include instructions to receive at least one command to submit educational testing materials for assessment.

17. The apparatus of claim 16, wherein the instructions to receive a response include instructions to receive an assessment of the educational testing materials.

18. The apparatus of claim 14, wherein the instructions to receive a command include instructions to receive information representing course enrollment information, and further comprising instructions to send the course enrollment information to a server operating within the learning management system.

19. A server system for operating in a learning management system, the server comprising:
at least one instance of processing hardware;
at least one bus system coupled to communicate with the processing hardware;
at least one computer-readable storage medium coupled to communicate with the processing hardware via the bus system, wherein the storage medium is encoded with computer-executable instructions that, when loaded into the processing hardware, transform the processing hardware to
receive a request from at least one client device operating within a learning management system, wherein the request relates to executing a command within the learning management system;
execute the command in response to the request;
evaluate whether the client device is a desktop client device having a first display screen of a first size or a mobile client device having a second display screen of a second size smaller than the first size; and
format a response to the command for rendering on the first or second display screen, based on whether the client device is the mobile client device.

20. The server system of claim 19, wherein the computer-readable storage medium further comprises a server-side learning management system and platform software, wherein the platform software is adapted to facilitate collaboration between a plurality of client devices and for managing documents within the learning management system.
